(19) United States
(12) Patent Application Publication
(10) Pub. No.: US 2013/0295926 A1
(43) Pub. Date: Nov. 7, 2013

(54) Method and Device for Processing Data in Mobile Communication Network

(71) Applicants: Juergen Michel, Munich (DE); Jian Feng Qiang, Haidian District (CN)

(72) Inventors: Juergen Michel, Munich (DE); Jian Feng Qiang, Haidian District (CN)

(73) Assignee: Nokia Siemens Networks Oy, Espoo (FI)

(21) Appl. No.: 13/876,204

(22) PCT Filed: Sep. 30, 2010
(86) PCT No.: PCT/CN2010/001532

§ 371 Date: Jun. 24, 2013

(51) Int. Cl. H04W 48/16

(52) U.S. Cl. CPC H04W 48/16
USPC 455/434

(57) ABSTRACT

A method and a device for processing data in a mobile communication network are provided, wherein a deployment information is distributed within a coverage area of a wide area system. Furthermore, a communication system is suggested including said device.

The invention relates to a method and to a device for processing data in a mobile communication network. In addition, an according system comprising at least one such device is suggested.

Data transmission becomes a growing portion of services provided by radio networks. A demand for data rate is increasing with new devices and multimedia services.

Such a boost in capacity is supplied by radio cells of reduced size (e.g., femto cells or home base stations that are deployed locally at the site where the user predominately requires high data rates), cooperative scheduling, flexible spectrum utilization or cognitive radio features.

Standardized macro cells pursuant to GSM, UMTS, LTE, etc. are deployed together with femto cells, pico cells, relay nodes, etc. thereby providing a heterogeneous network for a mobile terminal, which may have several possibilities to obtain a radio connection.

A femto cell (also referred to as home base station, home Node B, HeNB or home eNodeB) is a small cellular base station, typically designed for use in a home or small business. It may be connected to a service provider's network via a broadband access (e.g., via DSL or cable). The femto cell enables service providers to extend service coverage indoors, especially where access would otherwise be limited or unavailable. The concept of femto cells is applicable to all standards, including GSM, CDMA2000, TD-SCDMA, WiMAX and LTE.

A pico cell is a wireless communication system typically covering a small area, such as in-building offices, shopping malls, train stations or inside an aircraft. A pico cell could also be considered as a Wi-Fi access point.

Hence, the mobile terminal (e.g., a user equipment UE) may select a carrier in such a heterogeneous network. The heterogeneous network may provide a single radio access technology (RAT), several (in particular different) RATs (e.g., GSM, UMTS, LTE, any existing or upcoming communication technique or standard or any of its variant) and/or multi-carrier deployment(s).

In most scenarios, there is the problem that if several possibilities exist for a mobile terminal to get connected via a radio link, such connection may not be conducted in an efficient manner, e.g., the (multi-)carrier, cell or (multi-)RAT deployment may not be efficiently selected or utilized.

A cell selection procedure is achieved in idle mode after the mobile terminal conducted a cell search. This is described in 3GPP TS 36.304 “UE procedures in idle mode”. Hence, the UE is allowed to camp on a cell if specific criteria are fulfilled. Normally, a maximum reference signal received power (RSRP) based cell association is used. The procedure relies on information about carrier frequencies, and optionally cell parameters (system information block (SIB) Type 1 and 2, see 3GPP TS 25.331) that is received on a broadcast channel and stored from previously detected cells WE cell search procedure).

With an increasing number of heterogeneous networks, an increasing number of possibilities for a mobile terminal to get connected emerge, e.g.:
(a) Open subscriber group (OSG) users in a mixed macro cell and pico cell deployment may utilize different resources with varying ratios, e.g., three resources (carriers) per operator, two resources (carriers) for macro coverage and one resource (carrier) for the pico cell.
(b) In a multi-RAT and/or a multi-carrier overlay deployment, UMTS could be utilized for macro coverage and LTE for hot-spot coverage.
(c) A heterogeneous network may include macro cells, hot-spot OSG cells, pico closed subscriber group (CSG) cells, etc. for a mobile terminal to get connected.

In the heterogeneous network, due to the high density of hot-spots, relays (relay nodes) and femto cells within a macro cell coverage area, the (moving) mobile terminal may experience the following problems:
(1) The mobile terminal conducts measurements in a large frequency range, e.g., in order to detect the various possibilities to get connected (e.g., femto cells, pico cells, etc.). This consumes additional energy and thus reduces the standby time of the mobile terminal.
(2) A cell (re-)selection rate is increased in idle mode. The mobile terminal has to decode system information in the new camping cell. This activity also requires energy from the mobile terminal's battery and thus reduces its runtime.
(3) A handover rate for the UE increases with a high density of pico cells when the UE is in connected mode. The handover requires additional signaling and further measurements to be conducted. This consumes energy and stresses the battery runtime of the mobile terminal. In addition, handovers may occur in an inefficient manner.

Hence, it is a disadvantage that in a high density carrier deployment providing several possibilities or at least potential possibilities for a mobile terminal to obtain measurement data and/or to get connected to, the mobile terminal's activity in this regard requires additional battery power that reduces the standby time.

The problem to be solved is to overcome the disadvantages mentioned above and in particular to provide an efficient solution for a mobile terminal to enhance its runtime in a high-density carrier and/or RAT environment.

This problem is solved according to the features of the independent claims. Further embodiments result from the depending claims.

In order to overcome this problem, a method for processing data in a mobile communication network is provided, wherein a deployment information is distributed within a coverage area of a wide area system.

It is noted that the wide area system could be at least one macro cell base station spanning at least one cell of a mobile communication system. The macro cell base station may be a base transceiver station according to at least one telecommunication standard, e.g., GSM, UMTS, LTE, LTE-A, etc.

It is further noted that the deployment information distributed is preferably valid within the coverage area. It is also noted that the deployment information can be distributed within a coverage area of at least one wide area base station.

Hence, a mobile terminal may utilize this deployment information and could decide to which base station it gets connected based on the deployment information. The mobile terminal does not have to conduct measurements to every local cell of a heterogeneous deployment of local base stations by itself, which results in a significant reduction of energy consumption and thus saves battery power for the mobile terminal.

It is noted that at least one local cell may be deployed within the coverage area of the wide area system. The local cell may be a femto cell (home cell), a hot spot cell, any type of pico cell, a cell of a relay node, etc. The base station of the wide area system may advertise the deployment information (e.g., resources, RATs, carriers, frequency bands, etc. of the local cells) via a broadcast control channel.

In an embodiment, the deployment information comprises a heterogeneous co-channel deployment information that relates to radio resources supplied by at least one local cell base station within the coverage area of a wide area system.

In another embodiment, the radio resources comprise at least one deployed carrier or at least one component carrier.

The radio resource may be based on a radio resource according to a telecommunication standard, e.g., GSM, UMTS, LTE, LTE-A, etc. The radio resource may be a carrier or a multicarrier thereof.

In a further embodiment, the radio resources are provided by at least one of the following entities:
a home base station;
a pico cell base station;
a hot spot cell base station;
a WLAN base station;
a relay node.

All these base stations may be used to span a local cell that is at least partially covered by the coverage area of the wide area system, e.g., a cell of a macro cell base station of a mobile telecommunication system provider.

In a next embodiment, the deployment information is conveyed via at least one broadcast message.

It is also an embodiment that the deployment information comprises a PCI range information in particular of a closed subscriber group and/or of an open subscriber group.

Hence, the solution presented may in particular improve the mobile terminal's standby time by instructing mobile terminals of a CSG to select a resource (carrier) of this CSG. In other words, CSG mobile terminals may prefer using CSG cells and non-CSG mobile terminals may prefer using OSG cells, which can be facilitated by providing said deployment information. Energy-consuming measurements to the non-relevant local cells can thus be avoided for a particular mobile terminal.

Pursuant to another embodiment, the deployment information comprises a number of local cells deployed in the coverage area of the wide area system.

According to an embodiment, the deployment information comprises a sum of coverage areas of local cells divided by a coverage area of the wide area system.

The local cell may be a home cell, femto cell, pico cell, hot spot cell, WLAN cell, etc. The local cell may be a cell of a closed subscriber group (CSG) or of an open subscriber group (OSG). The local cell may also be a cell supplied by a relay node.

According to another embodiment, a mobile terminal is connected based on the deployment information.

Hence, the deployment information is utilized when a mobile terminal is connected to a base station, be it a base station of the wide area system or to a local cell. Also, the deployment information can be considered for handing over the mobile terminal between cells. In particular, the deployment density of the local cells may efficiently affect the way a mobile terminal is connected.

In yet another embodiment, the deployment information is conveyed to at least one mobile terminal, to at least one base station or to a central entity.

Hence, not only the mobile terminal could be a recipient of the deployment information, also the local cell base station may use it in order to facilitate, e.g., a handover decision for a particular mobile terminal. For example, a target local cell may use the deployment information to validate, conduct and/or confirm a handover process.

In addition, adjacent wide area base stations could convey or exchange the deployment information regarding their local cells (within their respective coverage area) over the broadcast control channel or by an inter-base station interface, such as an X2 interface.

The deployment information could also be conveyed to the central entity, e.g., a central server like an OAM server or a management system.

Basically, the deployment information could be gathered at different locations and/or by different entities of the communication network. The deployment information can then be processed or utilized or conveyed to other entities of the communication network.

According to a next embodiment, the deployment information comprises at least one parameter that is configured, in particular pre-configured during network planning or configured by a management system.

It is also an embodiment that the deployment information comprises at least one parameter that is measured.

The at least one parameter can be measured by the mobile terminal, the at least one local cell or the wide area system.

The at least one parameter may refer to a power level, in particular a transmission power level, a power saving mode information (indicating, e.g., that a base station is switched off for power saving purposes), a carrier flag indicating a macro or pico access type information, a PCI range (be it an allocated PCI range or an unallocated PCI range, or a PCI range for a pico cell or a macro cell).

The measured parameter could be a parameter measured by the mobile terminal and/or by any base station or by a management entity.

The problem stated above is also solved by a device for processing data in a mobile communication network comprising a processing unit that is arranged
for distributing a deployment information within a coverage area of a wide area system.

It is noted that the steps of the method stated herein may be executable on this processing unit as well.

It is further noted that said processing unit can comprise at least one, in particular several means that are arranged to execute the steps of the method described herein. The means may be logically or physically separated; in particular several logically separate means could be combined in at least one physical unit.

Said processing unit may comprise at least one of the following: a processor, a microcontroller, a hard-wired circuit, an ASIC, an FPGA, a logic device.

According to an embodiment, said device is a component of the mobile communication network, in particular a base station, a mobile terminal or a management entity.

The solution provided herein further comprises a computer program product directly loadable into a memory of a digital computer, comprising software code portions for performing the steps of the method as described herein.

In addition, the problem stated above is solved by a computer-readable medium, e.g., storage of any kind, having computer-executable instructions adapted to cause a computer system to perform the method as described herein.

Furthermore, the problem stated above is solved by a communication system comprising at least one device as described herein.

Embodiments of the invention are shown and illustrated in the following figures:

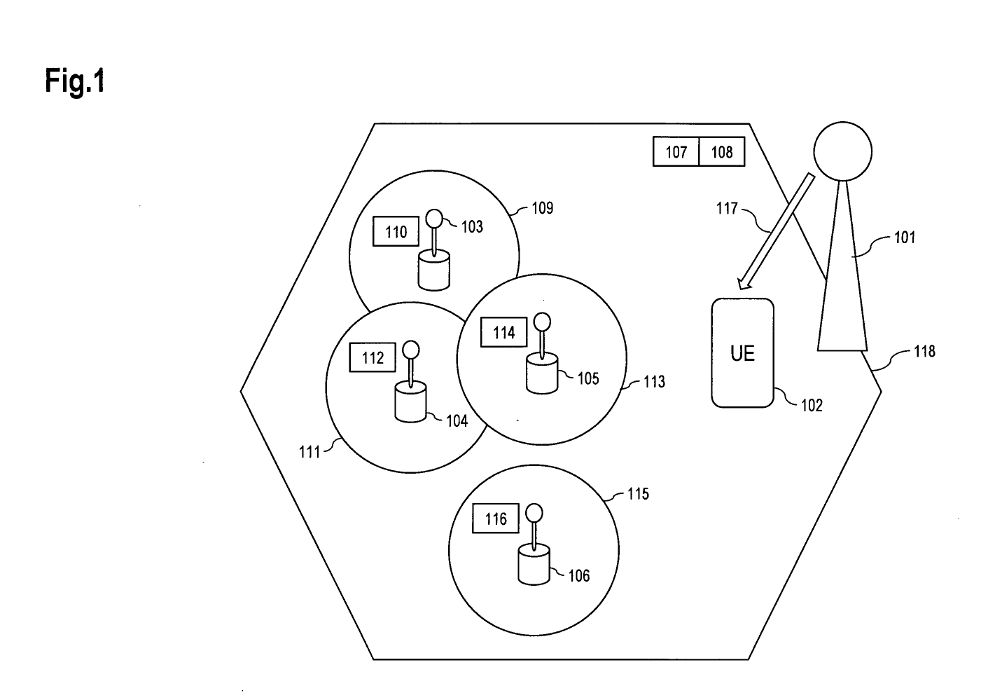

FIG. 1 shows a schematic diagram visualizing a broadcast of a deployment information in a mobile network comprising a macro base station and several pico cell base stations;

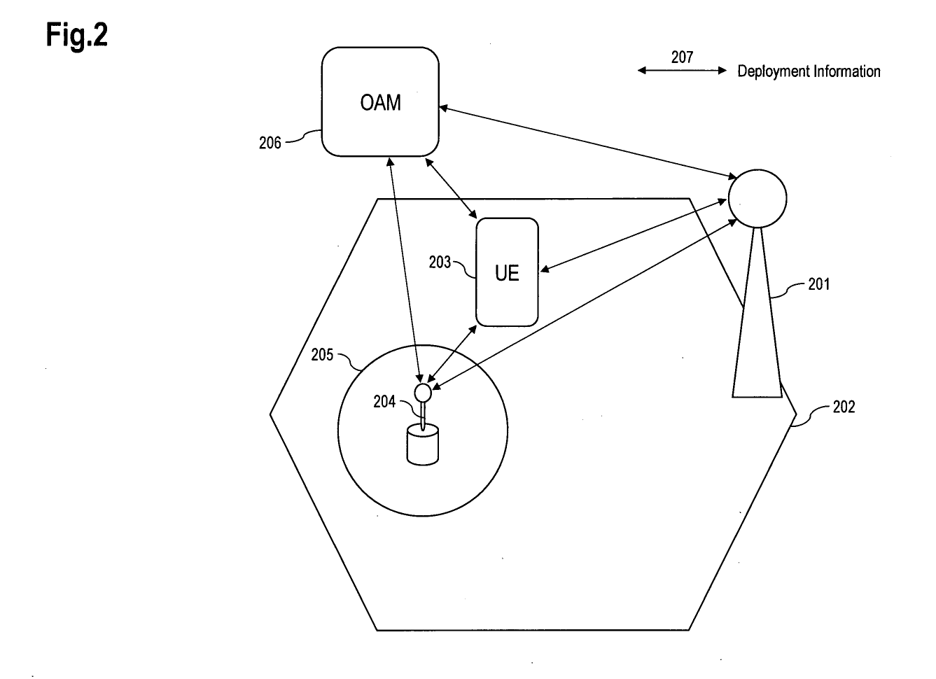

FIG. 2 shows a schematic block diagram comprising a macro cell base station, a pico cell base station and a UE within the coverage area of the macro cell and a separate management entity, wherein deployment information is exchanged between these units.

The approach presented in particular suggests that a wide area cell distributes a (heterogeneous co-channel) deployment information related to various types of radio cells or deployments, e.g., femto cells (home base station, home eNodeB), pico cells, hotspot cells, etc. per deployed carrier (e.g., in UMTS, LTE, etc.) or component carrier (e.g., in LTE-A, etc.) in the wide area system coverage.

The deployment information may comprise a local cell density, a CSG physical cell identity (PCI) range, etc. The deployment information may be distributed via broadcast or via a dedicated signaling procedure to a mobile terminal (also referred to as user equipment, UE) or to a related base station for the mobile terminal via a backhaul network and is in particular valid within the coverage area of the broadcast or dedicated signaling.

For example, a serving base station for the mobile terminal can be selected considering the deployment information, in particular a “deployment density of local cells” metric criterion.

This metric can be based on or defined by at least one parameter conveyed via a message, in particular a signaling message. The at least one parameter can be configured (e.g., preconfigured with values from a network planning tool) and/or measured. The metric can be considered fulfilled in case the value determined reaches and/or exceeds a target value (threshold value).

For example, a wide area cell could advertise the deployment density of pico cells and/or hot spot cells in its coverage area via its cell broadcast channel.

The aforementioned “deployment density of local cells” may be
(a) A number of local cells deployed in a macro cell coverage.
(b) A sum of coverage areas of local cells divided by a coverage area of the overlay macro cell.

The aforementioned deployment information may comprise:
A co-channel deployed density of hot spot cells (e.g., OSG cells with low transmission power) in the coverage area.
A co-channel deployed CSG and/or home cell (femto cell) density in the coverage area.
A co-channel deployed density of relay nodes in the coverage area.
A transmission power level per macro and/or pico cell or an upper threshold of CSG and/or femto cell (home eNB) transmit power level.
A power saving mode information indicating, e.g., if a base station is switched off for power saving purposes.
A carrier flag that indicates that a carrier is one of the following access types: macro cell (only), pico cell (only), CSG (only), mixed cell (e.g., macro and CSG), etc. This allows fast carrier frequency selection for the mobile terminal.
A PCI range for (neighboring) macro cells, a PCI range for OSG hot-spot cells within the coverage of the macro cell. This enables a fast cell search and a proper cell selection for the mobile terminal.
An (un-)allocated PCI range for OSG and/or CSG cells to enable a fast setup for a base station, e.g., a NodeB or an eNodeB.

The approach is also applicable in a device-to-device (D2D) scenario.
(a) In a network-supported scenario, a base station (e.g., eNB) may send additional information to related devices, such as an originating device ID and a (range of) terminating device ID(s). This may help to efficiently establish D2D radio communication links by skipping device IDs that are out of range in a certain cell and/or frequency. Hence, devices do not try to search for devices that are far away from each other or not present in, e.g., the same macro cell when the intention is to do D2D communication. In order to determine the set of devices, a specific UE can be paged in a specific macro cell or a specific set of macro cells.
(b) A device flag and/or control message could be supplied that prevents fast moving UEs or far-reaching UEs from establishing a direct D2D communication link via a base station. Instead, a slowly moving UE could setup a direct D2D communication link via the network. Since the range of devices is short, D2D communication is favorable if the devices are not moving fast (preferably the devices are nearly static). The network may detect a speed of the UE via channel estimation or may rely on the UE's capability to measure its speed. Then, a flag of the broadcast channel could be used to disallow D2D communication for high speed UEs.

A high-speed UE may select a proper macro coverage carrier in idle mode or in connected mode using the deployment information, e.g., a local cell density.

For example, a PCI range of OSG hot spot cells and/or CSG cells per carrier may be distributed by the macro cell to instruct OSG UEs and/or CSG UEs to access the relevant carrier. For example a CSG UE may prefer selecting a macro carrier with a high CSG deployment density instead of a macro carrier with a low or none CSG deployment density.

This approach provides the following advantages:
less intra or inter-frequency measurements; unnecessary (cell-reselect, handover) UE measurements or monitoring activities are avoided leading to less energy consumption and thereby increasing the UE's runtime;
an efficient and limited cell search is conducted;
an automatic PCI allocation is achieved in an uncoordinated local cell deployment scenario.

The deployment information may not have to be conveyed (e.g., broadcast or distributed) to the UEs. A target cell (e.g., pico cell) that is selected for handover may use the deployment information to validate, conduct or confirm the handover process.

### Exemplary Use Cases for the Deployment Information

FIG. 1 shows a schematic diagram visualizing a broadcast of a deployment information 117 in a mobile network comprising a macro base station 101 spanning a macro cell 118 supplying two carrier frequencies 107 and 108. In addition, a pico cell base station 103 spans a cell 109 using a carrier frequency 110, a pico cell base station 104 spans a cell 111 using a carrier frequency 112, a pico cell base station 105 spans a cell 113 using a carrier frequency 114 and a pico cell 106 spans a cell 115 using a carrier frequency 116. The deployment information 117 is conveyed from the macro base station 101 to a UE 102. As an option (not shown in FIG. 1), the deployment information 117 may be conveyed to at least one of the pico cell base stations 104 to 106.

If the carrier frequencies 107 and 110, 112, 114, 116 are identical, the pico cells at least partially operate on the same carrier frequency that is also used by the macro cell 118. Hence, the UE 102 utilizing such carrier frequency and moving across the macro cell coverage area may require handovers to be conducted although the UE 102 remains within the coverage area of the macro cell 118.

This situation becomes more relevant if the pico cells 109, 111, 113 and 115 are configured for a closed user group only. In such case, the UE moving across the macro cell 118 and operating on the carrier frequency 107 would experience “white spots” according to the cell coverage areas 109, 111, 113 and 115 in case all pico cells of FIG. 1 are part of a closed user group and the UE 102 is not. Such white spots result in coverage holes for the UE 102.

On the other hand, the macro cell base station 101 in this scenario also provides the carrier frequency 108 (which is different from the carrier frequencies 110, 112, 114 and 116) that fully covers the white spots without any need for the UE 102 (moving across the macro cell 118) to conduct a handover.

If the UE 102 is aware of the pico cell density for this component carrier frequency 107 within the specific area of the macro cell 118, the UE 102 during cell selection could prioritize selecting a macro cell carrier frequency with a low co-channel pico cell deployment density (in the example of FIG. 1: the UE 102 could select the carrier frequency 108, because it cannot get connected to any of the pico cells as it is not a member of a closed user group).

Hence, so-called SpeedStateScaleFactors according to 3GPP TS36.331 V9.0.0 provided by a higher layer can be set. The SpeedStateScaleFactors describe four rates in a medium mobility state and four rates in a high mobility state plus a normal mobility (defined in 3GPP TS 36.304 V9.1.0) that are provided by higher layers. In addition, a speed of the UE could be measured by the Doppler Effect.

### Exemplary Implementation of the Deployment Information

A wide area base station (e.g., a macro cell base station) may advertise a deployment ratio of pico cells and/or hot spot cells in its coverage area via a broadcast control channel. In addition, the wide area base station may convey carriers and/or a frequency band of at least one RAT via the broadcast control channel.

A group of neighboring wide area base stations could advertise the deployment density of cell, pico, hot spot or relay cells in their coverage area over the broadcast control channel.

A group of neighboring wide area base stations may advertise the deployment density of home, pico, hot spot or relay cells in their coverage area and a frequency resource (e.g., frequency band) of an overlay redundancy RAT wide area base station group via said broadcast control channel.

A base station could advertise the deployment density of home, pico, hot spot or relay cells in its coverage area to a central server entity like an operation, administration and maintenance (OAM) server. UEs may access such server information via dedicated communication, e.g., via dedicated distribution of cognitive pilot channel information.

In a cluster of local access cells without wide area cell coverage, a master cell or each cell may distribute the deployment information.

### Example: Maintaining and/or Distributing the Deployment Information

The deployment information can be preconfigured or set by an operation and maintenance entity. The deployment information could also be based on UE measurements.

### Example: OAM-based Deployment Information

A topological deployment information in a heterogeneous co-channel deployment could be obtained from an operator's database.

For example, a HeNB Management System (HeMS) may support procedures for identity and location verification of the HeNB, whether the HeNB is accessible within the operator's private secure network domain or over the Internet (e.g., via DSL or the like), see 3GPP TS 32.593 V9.0.0. Further, location management parameters in the OAM database and/or server include information elements like a list of network elements' IDs (such as HeNB IDs), a LastLocationDeterminationTime, a Latitude, a Longitude, a Location Area ID (LAI), a Routing Area Code (RAC), see 3GPP TS 32.592 V9.0.0.

Based on the existing heterogeneous network base station deployment information, the OAM database could be supplemented with heterogeneous co-channel deployment information, in particular with regard to a femto cell density within the macro cell carrier, a PCI range of CSG and/or OSG per carrier.

### Example: Measurement-based Deployment Information

The deployment information can be based on measurements and/or propagation models, including, e.g., penetration loss of walls, etc. Another benefit of deployment information considering measurements is the actuality of the data. Hence, in environments with a high density of small cells the deployment information can be dynamically determined and/or updated, which is beneficial due to the fact that such small cells may be frequently switched on and off, e.g., for power-saving reasons.

The UE may send measurement information, calculated or derived values or metrics to a central entity and the network may adapt a data base accordingly.

A UE may collect measurements on identified macro and/or pico cell IDs (which could be classified by their broadcast respective transmission power), determine the received macro cell power during idle mode, and delivers the measurements when connected to a wide area network. From such measurements the wide area base station entity calculates the small cell deployment density within a macro cell, e.g., by counting the number of different small cell IDs.

As an option, the base station may collect measurements and forward such measurements or derived data from the measurements to an OAM entity.

FIG. 2 shows an schematic block diagram comprising a macro cell base station 201 spanning a macro cell 202, a pico cell base station 204 spanning a pico cell 205 within the coverage area of the macro cell 202. In addition, a UE 203 is arranged within the macro cell 202. Also, a management entity OAM 206 is deployed at a central location. FIG. 2 in particular visualizes some of the communication paths that could be utilized for deployment information 207: The deployment information may be configured or pre-set by the management entity OAM 206 and conveyed to the pico cell base station 204, the macro cell base station 201 or the UE 203. On the other hand, the management entity OAM 206 may collect information from all these units (or a portion thereof) to adjust the deployment information (e.g., stored in a database). Hence, measurements conducted by the base stations 204, 201 or the UE 203 can be forwarded (also information based on such measurements can be forwarded) to the management entity OAM 206. Accordingly, the pico cell base station may conduct and/or collect data (e.g., measurements) that could be used as deployment information and convey such information also to the UE 203 and/or to the macro cell base station 201. The UE 203 may conduct measurements, convey or broadcast some of its properties (e.g., CSG only) that could be utilized for connecting the UE 203 to pico cells within the coverage area of the macro cell 202. The macro cell base station 201 conveys deployment information to some or all of the other entities shown in FIG. 2 and may receive deployment information from none, some or all of these entities.

Dependent on the scenario utilized, the UE 203 may traverse the macro cell 202 with a minimized number of measurements for local cells, in particular such local cells to which it cannot be connected or handed over (e.g., because the UE 203 is not part of the CSG). This information can be collected and utilized accordingly by the local cell base station 204, the macro cell base station 201 and/or the management entity OAM 206.

It is noted that the block structure shown in any of the figures, could be implemented by a person skilled in the art in various ways, e.g., by providing various physical units. The local base stations, the macro cell base station or the mobile terminal could be realized each as at least one logical entity that may comprise an entity that is deployed as hardware, program code, e.g., software and/or firmware, running on a processor, e.g., a computer, microcontroller, ASIC, FPGA and/or any other logic device.

The functionality described herein may be based on an existing component of a (wireless) network, which is extended by means of software and/or hardware.

The base stations 101, 103 to 106, 201, 204, the mobile terminal 102, 203 and/or the management entity OAM 206 may each comprise at least one physical or logical processing unit that is arranged for distributing a deployment information within a coverage area of a wide area system.

### LIST OF ABBREVIATIONS

3GPP 3^{rd} Generation Partnership Project
CDMA Code Division Multiple Access
CSG Closed Subscriber Group
D2D Device-To-Device
DSL Digital Subscriber Line
eNB evolved NodeB
eNodeB evolved NodeB
GSM Global System for Mobile Communications
HeMS HeNB Management System
HeNB Home eNB
ID Identification
LAI Location Area ID
LTE Long-Term Evolution
LTE-A LTE Advanced
NodeB base station, base transceiver station
OAM Operation Administration and Maintenance
OSG Open Subscriber Group
PCI Physical Cell Identifier
RAC Routing Area Code
RAT Radio Access Technology
RSRP Reference Signal Received Power
SIB System Information Block
TD-SCDMA Time Division Synchronous CDMA
UE User Equipment (mobile device or terminal)
UMTS Universal Mobile Telecommunications System
WiMAX Worldwide Interoperability for Microwave Access

1. A method for processing data in a mobile communication network,
wherein a deployment information is distributed within a coverage area of a wide area system.

2. The method according to claim 1, wherein the deployment information comprises a heterogeneous co-channel deployment information that relates to radio resources supplied by at least one local cell base station within the coverage area of a wide area system.

3. The method according to claim 2, wherein the radio resources comprise at least one deployed carrier or at least one component carrier.

4. The method according to claim 2, wherein the radio resources are provided by at least one of the following entities:
a home base station;
a pico cell base station;
a hot spot cell base station;
a LAN base station;
a relay node.

5. The method according to claim 1, wherein the deployment information is conveyed via at least one broadcast message.

6. The method according to claim 1, wherein the deployment information comprises a PCI range information in particular of a closed subscriber group and/or of an open subscriber group.

7. The method according to claim 1, wherein the deployment information comprises a number of local cells deployed in the coverage area of the wide area system.

8. The method according to claim 1, wherein the deployment information comprises a sum of coverage areas of local cells divided by a coverage area of the wide area system.

9. The method according to claim 1, wherein a mobile terminal is connected based on the deployment information.

10. The method according to claim 1, wherein the deployment information is conveyed to at least one mobile terminal, to at least one base station or to a central entity.

11. The method according to claim 1, wherein the deployment information comprises at least one parameter that is configured, in particular pre-configured during network planning or configured by a management system.

12. The method according to claim 1, wherein the deployment information comprises at least one parameter that is measured.

13. A device for processing data in a mobile communication network, comprising a processing unit that is arranged for distributing a deployment information within a coverage area of a wide area system.

14. The device according to claim 13, wherein said device is a component of the mobile communication network, in particular a base station, a mobile terminal or a management entity.

15. A communication system comprising at least one device according to claim 13.
